(19) United States
(12) Patent Application Publication
(10) Pub. No.: US 2016/0110779 A1
(43) Pub. Date: Apr. 21, 2016

(54) METHOD, SYSTEM AND RECORDING MEDIUM FOR PROVIDING SEARCH FUNCTION AND SEARCH RESULT ON MOBILE MESSENGER

(71) Applicant: NAVER Corporation, Seongnam-si (KR)

(72) Inventor: Donghyun Gu, Seongnam-si (KR)

(21) Appl. No.: 14/844,662

(22) Filed: Sep. 3, 2015

(30) Foreign Application Priority Data
Oct. 16, 2014 (KR) 10-2014-0139828

(51) Int. Cl. G06Q 30/02; H04L 12/58

(52) U.S. Cl. CPC G06Q 30/0282; G06Q 30/0256; H04L 51/04

(57) ABSTRACT

A search result providing method includes providing a search function on a messenger and information associated with stores as a search result, analyzing a quality factor indicating a store quality associated with the messenger with respect to each store, and sorting the search result by determining a ranking of a store based on the quality factor.

### CROSS-REFERENCE TO RELATED APPLICATION

This application claims priority from and the benefit of Korean Patent Application No. 10-2014-0139828, filed on Oct. 16, 2014, the disclosure of which is incorporated herein in its entirety by reference.

### BACKGROUND

1. Field

Example embodiments of the present invention relate to technology for sorting a search result to be displayed on a messenger.

2. Description of the Background

With the current development in information technology (IT), users may connect to the Internet without restrictions on time or occasions. Accordingly, users may search for information regardless of time or space, and may utilize desired contents and services.

Further, with the development in mobile communication technology, the distribution of mobile terminals, such as a smartphone, a tablet, and a wearable computer, is on significant increase. Many mobile search users search for information using mobile terminals.

As mobile terminals are generally used, a mobile messenger (also known as mobile messaging or mobile instant messaging (MIM)) is one of the fields that has been gaining attention. Accordingly, it has become more important to consider the interactions between mobile media and users.

### SUMMARY

Some example embodiments of the present invention provide a search result providing method and a system that provide a search function on a mobile messenger and sort a search result to be displayed on the messenger.

Some example embodiments also provide a search result providing method and a system that may sort a search result based on a ranking determining element in which features of a mobile messenger are applied.

According to at least one example embodiment, there is provided a search result providing method implemented in a computer including a processor, wherein the method provides a search function on a messenger and provides information associated with stores as a search result by the search function, and includes analyzing, by the processor, a quality factor indicating a store quality associated with the messenger with respect to each store, and sorting, by the processor, the search result by determining the ranking of a store based on the quality factor.

Analyzing may include analyzing the quality factor based on at least one of a store connection amount indicating a conversation connection level between users and the store through the messenger and a conversation content correlation indicating a correlation between conversation contents of the users through the messenger and the store.

Analyzing may include analyzing a store connection amount indicating a conversation connection level between users and the store through the messenger, and calculating the store connection amount based on at least one of conversation duration time and conversation frequency between a user and the store.

Analyzing may include analyzing a conversation content correlation indicating a correlation between conversation contents of the users through the messenger and the store, and calculating the conversation content correlation based on the number of times that a keyword associated with the store has appeared in the conversation contents.

Analyzing may include analyzing a store connection amount indicating a conversation connection level between users and the store through the messenger, determining a unit session for analyzing the store connection amount in a conversation session in which a user and the store are connected, and calculating the store connection amount based on at least one of the number of unit sessions and session duration time.

Analyzing may include analyzing a conversation content correlation indicating a correlation between conversation contents of the users through the messenger and the store, determining a unit session for analyzing the conversion content correlation in a conversation session in which the users are connected, and calculating the conversation content correlation based on the number of times that a keyword associated with the store has appeared in the conversation contents.

Analyzing may include determining, as the unit session, a session from an appearance point in time of a predefined seed keyword in the conversation session to a point in time at which a desired period of time has elapsed after the appearance of the seed keyword, using the seed keyword.

Analyzing may include determining, as the unit session, a session from a start point in time of a conversation to a point in time of a predetermined time in which no reply is received after an input of the last message in the conversation.

Analyzing may include analyzing the quality factor based on at least one of a store response rate indicating a rate at which the store has responded to a request of a user for a specific service of the store using the messenger, a store accessibility indicating the distance between a location of the user using the messenger and a physical location associated with and/or referenced in the store, and the popularity of the store among users using the store.

Sorting may include determining the ranking of the store by applying a weight to the quality factor based on at least one of a correlation between a user and the store and a correlation between a friend having set a relationship with the user and the store.

The weight may be determined based on at least one of whether a messenger conversion of the user or the friend is used to analyze the quality factor, whether a search history by the user or the friend is present, whether a conversation history with the user or the friend is present in the messenger, and whether a favorites or friend registration history by the user or the friend is present in the messenger.

Sorting may include determining the ranking of the store by applying a weight to the quality factor based on the search frequency for each time zone of the store through the search function.

According to at least one example embodiment, there is provided a search result providing system including a processor and a memory, wherein the processor is configured to provide a search function on a messenger and to provide information associated with stores as a search result by the search function, and includes an analyzer configured to analyze a quality factor indicating a store quality associated with the messenger with respect to each store, and a provider configured to sort the search result by determining the ranking of a store based on the quality factor.

The analyzer may be further configured to analyze the quality factor based on at least one of a store connection amount indicating a conversation connection level between users and a store through the messenger and a conversation content correlation indicating a correlation between conversation contents of the users through the messenger and the store.

The analyzer may be further configured to analyze a store connection amount indicating a conversation connection level between users and the store through the messenger, to determine a unit session for analyzing the store connection amount in a conversation session in which a user and the store are connected, and to calculate the store connection amount based on at least one of the number of unit sessions and a session duration time.

The analyzer may be further configured to analyze a conversation content correlation indicating a correlation between conversation contents of the users through the messenger and the store, to determine a unit session for analyzing the conversion content correlation in a conversation session in which the users are connected, and to calculate the conversation content correlation based on the number of times that a keyword associated with the store has appeared in the conversation content.

The analyzer may be further configured to analyze the quality factor based on at least one of a store response rate indicating the rate at which the store has responded to a request of a user for a specific service of the store using the messenger, a store accessibility indicating the distance between a location of the user using the messenger and a physical location associated with and/or referenced in the store, and the popularity of the store among users using the store. The provider may be further configured to determine the ranking of the store by applying a weight to the quality factor based on at least one of a correlation between a user and the store and a correlation between a friend having set a relationship with the user and the store.

The provider may be further configured to determine the ranking of the store by applying a weight to the quality factor based on a search frequency for each time zone of the store through the search function.

According to at least one example embodiment, there is provided a non-transitory computer-readable medium storing computer-readable instructions, when executed by a processor, control a computer system to provide a search function on a messenger and information associated with stores as a search result by the search function, and to analyze a quality factor indicating the store quality associated with the messenger with respect to each store, and sort the search result by determining the ranking of a store based on the quality factor.

It is to be understood that both the foregoing general description and the following detailed description are explanatory and are intended to provide further explanation of the example embodiments as claimed.

According to at least one example embodiment, it is possible to induce traffic of a new model and to improve the usability and availability of a mobile messenger by providing a search function to the mobile messenger.

According to at least one example embodiment, it is possible to provide a search result optimized for a mobile messenger by providing a commercial search result based on a ranking determining element in which features of the mobile messenger are applied.

### BRIEF DESCRIPTION OF THE DRAWINGS

The foregoing and other features of the example embodiments of the present invention will be apparent from the more particular description of non-limiting embodiments, as illustrated in the accompanying drawings in which like reference characters refer to like parts throughout the different views. The drawings are not necessarily to scale, emphasis instead being placed upon illustrating principles of inventive concepts. In the drawings:

FIG. 1 is a diagram illustrating a relationship between a user terminal and a search result providing system according to one example embodiment.

FIG. 2 is a block diagram illustrating a configuration of a search result providing system according to one example embodiment.

FIG. 3 is a flowchart illustrating a search result providing method according to an example embodiment.

FIG. 4 is a flowchart illustrating an example of a method of analyzing a store connection amount according one embodiment.

FIGS. 5 through 7 are examples to describe a method of identifying a unit session in a conversation session of a messenger according to one embodiment.

FIG. 8 is a flowchart illustrating an example of a method of analyzing a conversation content correlation according to one embodiment.

FIG. 9 is a flowchart illustrating an example of a method of determining a store ranking according to one embodiment.

FIG. 10 illustrates an example of a search result screen on which store rankings are displayed according to one embodiment.

FIG. 11 illustrates an example of a computer system according to one embodiment.

### DETAILED DESCRIPTION

Example embodiments of the present invention will now be described more fully with reference to the accompanying drawings. Example embodiments, may, however, be embodied in many different forms and should not be construed as being limited to the embodiments set forth herein; rather, these example embodiments are provided so that this disclosure will be thorough and complete, and will fully convey the scope of the example embodiments to those of ordinary skill in the art. In the drawings, the thicknesses of layers and regions are exaggerated for clarity. Like reference characters and/or numerals in the drawings denote like elements, and thus their description may be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”). As used herein the term “and/or” includes any and all combinations of one or more of the associated listed items.

It will be understood that, although the terms “first”, “second”, etc. may be used herein to describe various elements, components, regions, layers and/or sections. These elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof Expressions such as “at least one of,” when preceding a list of elements, modify the entire list of elements and do not modify the individual elements of the list.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein

Hereinafter, example embodiments will be described with reference to the accompanying drawings.

At least one example embodiment relates to applying a search module on a messenger, and more particularly, to technology for providing a search function on a mobile messenger and applying a ranking in a search result of the messenger.

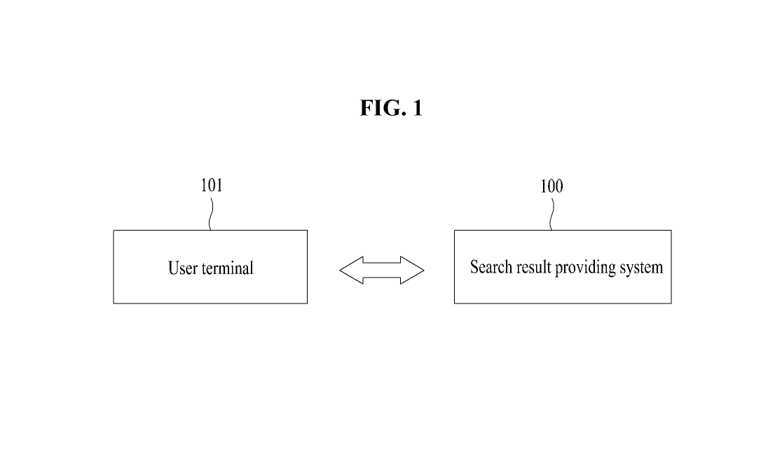

FIG. 1 is a diagram illustrating a relationship between a user terminal and a search result providing system according to some example embodiments. FIG. 1 illustrates a search result providing system 100 and a user terminal 101. In FIG. 1, an arrow indicator may indicate that data may be transmitted and received over a wired/wireless network between the search result providing system 100 and the user terminal 101.

The user terminal 101 may indicate any type of stationary or mobile terminal devices, such as a smartphone, a tablet, a personal computer (PC), or a laptop, capable of connecting to a website/mobile site associated with the search result providing system 100 or installing and executing a service exclusive application. Here, the user terminal 101 may perform the overall service configuration, such as a service screen configuration, data input, data transmission and reception, data storage, or the like, under the control of the website/mobile site or the service exclusive application.

The search result providing system 100 may be configured on a messenger platform that provides a messenger service and a search service to the user terminal 101 that is a client using the messenger service. Here, the search result providing system 100 may sort a search result by determining the ranking with respect to a search with a messenger application, or “messenger”, corresponding to the messenger platform and installed in the user terminal 101. In particular, the search result providing system 100 analyzes a ranking standard based on the features of the messenger, and sorts the search result based on the analyzed ranking standard.

The search result providing system 100 provides a result using the search function of the messenger, and may serve as a content platform that provides content through the messenger. The content platform may be advertisement platform for providing advertisements through the messenger. Here, the advertising platform may indicate a system that performs a bid for an advertisement, an advertisement-keyword matching, sorting of advertisements, and charging according to advertisements displayed. For example, the aforementioned advertising platform may correspond to an advertising platform that provides a search advertisement and/or a banner advertisement through the Internet.

The search function of the messenger performs the function of displaying a friend search result, a store search result, and a recent search log. Herein, a store to be searched for commercial intent may be included in a target to be displayed.

The search result providing system 100 may be configured to be included in a platform of a messenger server (not shown) that provides the messenger service. Alternatively, without being limited, the search result providing system 100 may be configured in a separate system from the messenger server to provide a search result on a search screen displayed on the messenger in interaction with the messenger server. Further, the search result providing system 100 may be configured so that at least a portion of constituent elements may be configured in a form of an application installed in the user terminal 101 or to be included in a platform that provides a service in a client-server environment.

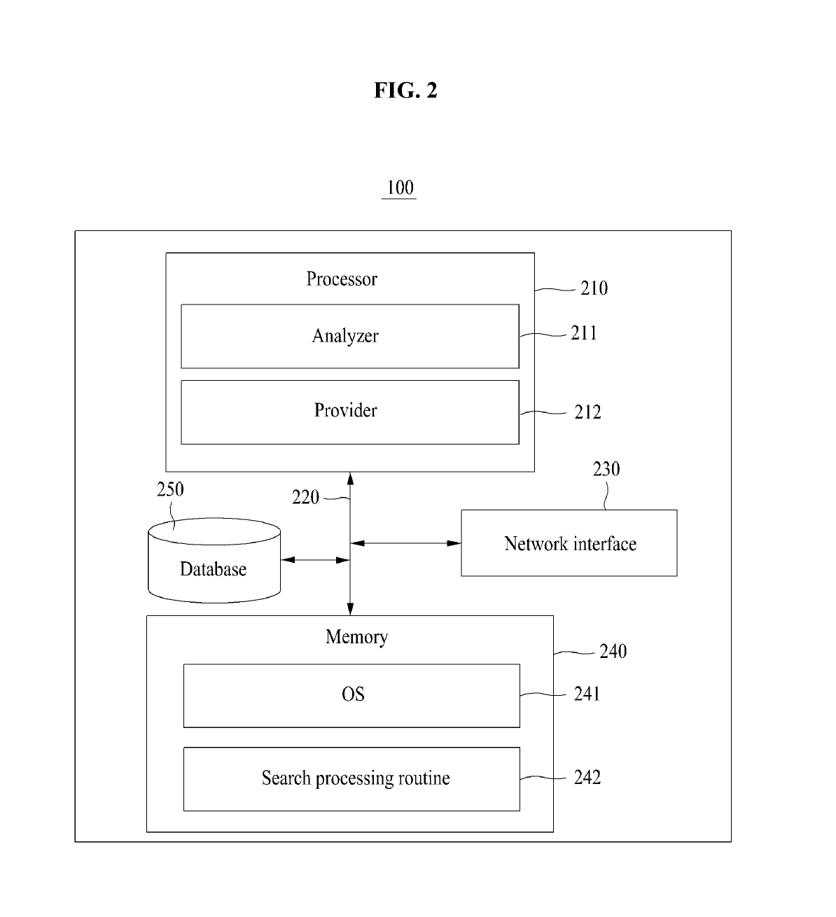

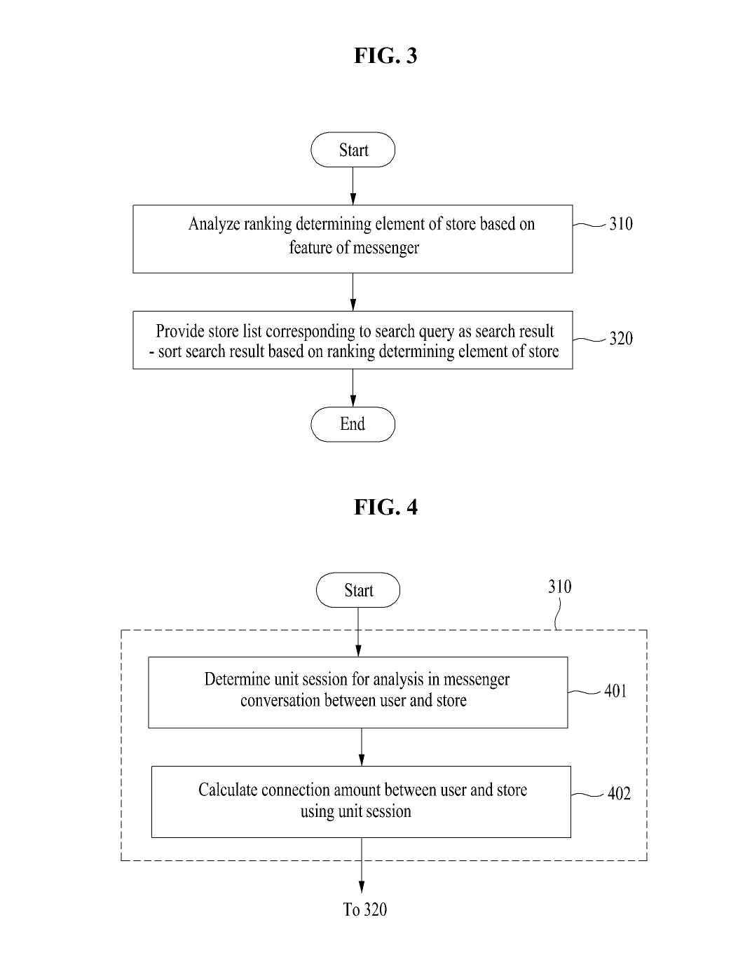

FIG. 2 is a block diagram illustrating a configuration of the search result providing system 100 according to one example embodiment, and FIG. 3 is a flowchart illustrating a search result providing method according to an example embodiment.

Referring to FIG. 2, the search result providing system 100 includes a processor 210, a bus 220, a network interface 230, a memory 240, and a database 250. The memory 240 includes an operating system (OS) 241 and a search processing routine 242. The processor 210 includes an analyzer 211 and a provider 212, which are two of the functions performed by the processor. According to other example embodiments, the search result providing system 100 may include additional number of constituent elements than the number of constituent elements of FIG. 2. However, many constituent elements according to the related art do not need to be clearly illustrated. For example, the search result providing system 100 may include other constituent elements such as a display or a transceiver.

The memory 240 may include a permanent mass storage device, such as a random access memory (RAM), a real only memory (ROM), or a disc drive, as a computer-readable storage medium. Also, program codes for the OS 241 and the search processing routine 242, and the like, may be stored in the memory 240. Such software constituent elements may be loaded from another computer-readable storage medium separate from the memory 240 using a drive mechanism (not shown). The other computer-readable storage medium may include, for example, a floppy drive, a disc, a tape, a DVD/CD-ROM drive, and a memory card. Software constituent elements may be loaded to the memory 240 through the network interface 230 instead of using the computer-readable storage medium.

The bus 220 enables communication and data transmission between the constituent elements of the search result providing system 100. The bus 220 may be configured using a high-speed serial bus, a parallel bus, a storage area network (SAN), and/or another appropriate communication technology.

The network interface 230 may be a computer hardware constituent element for connecting the search result providing system 100 to the computer network. The network interface 230 may connect the search result providing system 200 to the computer network through a wireless or wired connection.

The database 250 serves to store and maintain content such as an advertisement target to be displayed as a search result. Here, an advertisement target may indicate any type of targets to be retrieved for commercial intent. For example, the advertisement target may include a store name, a product name, a category name, and a site name. The advertisement target may include a bidding advertisement based on a bid amount input from an advertiser and a general advertisement having no bid amount. Although FIG. 2 illustrates that the database 250 is included in the search result providing system 200, the database 250 may be omitted or the entire or a portion of the database 250 may be present as an external database configured on a separate or different system based on system configuration method or environment.

The processor 210 is configured to process computer-readable instructions of a computer program by performing basic calculations, logic, and input/output operations of the search result providing system 100. The computer-readable instructions may be provided from the memory 240 or the network interface 230 to the processor 210 through the bus 220. The processor 210 is configured to execute program codes for the analyzer 211 and the provider 212. The program codes may be stored in a storage device such as the memory 240. When the program codes for the analyzer 211 and the provider 212 are executed by processor 210, the search result providing system 100 performs the operations 310 and 320 illustrated in FIG. 3.

Herein, content (for example, an advertisement) to be displayed as a search result is referred to as a “store”. In operation 310, the analyzer 211 analyzes the ranking determining element of a store based on the features of a messenger. Here, the ranking determining element may indicate a ranking standard of a store to be displayed as a search result for a search. Herein, the analyzer 211 analyzes a quality factor indicating the store quality on the messenger. The quality factor indicating the store quality may include at least one of a store connection amount indicating a conversation connection level between users and the store through a conversation function of the messenger, a conversation content correlation indicating a correlation between conversation contents of messenger users and the store, a store response rate indicating a rate of the store responding to a request of a messenger user, a store accessibility indicating a distance between a current location of the messenger user and the physical location associated with and/or referenced in the store, and a store popularity indicating a rate of the messenger users responding to the store. The quality factor that is the ranking determining element of the store may be analyzed with respect to the entire users of the messenger.

In operation 320, the provider 212 provides a store list corresponding to a search query as a search result in response to the search query input through the messenger. Herein, a search may inclusively indicate any type of behaviors represented as the search intent such as inputting a keyword or clicking a link. That is, the search query may indicate any type of search queries input through the messenger, for example, a search query input by inputting content in a search window of the messenger and a search query input through a link displayed on the search window or an area except for the search window. Here, the provider 212 sorts stores included in the search result based on quality factor values by applying the quality factor as a store ranking standard. Further, the provider 212 may determine the rankings of the stores by applying a weight to the quality factor and may sort the search result based on the determined rankings For example, the provider 212 may apply a social weight indicating a correlation between a store and friends included in a social graph of a user based on the social graph of the user formed on the messenger. As another example, the provider 212 may provide a time weight indicating a search frequency for each time zone of a store based on a previous search history through a search function of the messenger. As another example, an advertisement amount of a store may be used as a weight. Here, the advertisement amount may indicate a highest bidding amount proposed by an advertiser that has participated in a bid to secure a display opportunity corresponding to a desired (or alternatively predetermined) standard through the messenger that serves as a publisher.

FIG. 4 is a flowchart illustrating an example of a method of analyzing a store connection amount according to an example embodiment. Operations 401 and 402 included in the store connection amount analyzing method of FIG. 4 is performed by the analyzer 211 of the search result providing system 100 described above with reference to FIGS. 2 and 3.

In operation 401, the analyzer 211 determines a unit session for analyzing the store connection amount in a conversation session between a user and the store through the messenger. Here, the conversation session between the user and the store may be connected through a specific link, or may be connected using an official account in a form of a bot that provides a variety of information associated with the store on the messenger.

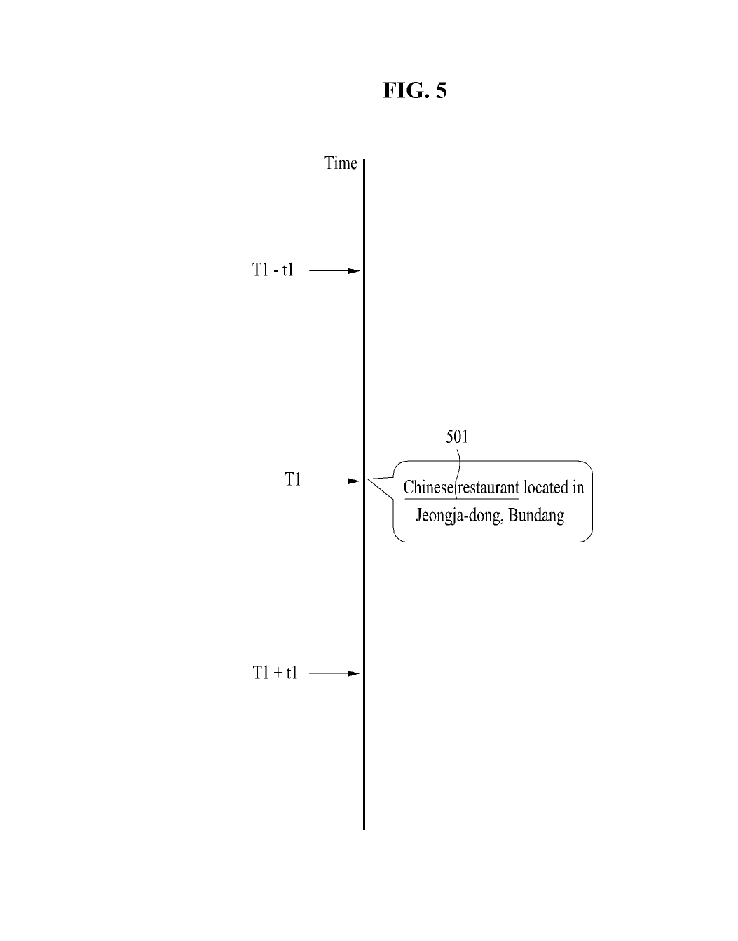

For example, the analyzer 211 may identify a desired (or alternatively predetermined) time duration during a messenger conversation as a unit session based on a seed keyword predefined in the conversation session between the user and the store. In this example, the seed keyword may refer to a keyword having a business propensity, and may be predefined through an advertisement database included in an advertising platform or a search database of a search engine. That is, the analyzer 211 may verify whether the seed keyword or the link, for example, abcde.com/ . . . query=“seed kwd” including the seed keyword is included in the messenger conversation and may determine a unit session based on a result of verifying. For example, referring to FIG. 5, the analyzer 211 may separate, as a unit session, a time duration from a previous point in time (T1−t1) of a predetermined time (t1) before an appearance of a seed keyword 501 to a point in time (T1+t1) at which the predetermined time (t1) is elapsed after the appearance of the seed keyword 501, based on a point in time (T1) at which the seed keyword 501 is recognized from conversation content between a user and a store. Alternatively, the analyzer 211 may separate, as a unit session, a time duration from the point in time (T1) at which the seed keyword 501 is recognized to the point in time (T1+t1) at which the predetermined time (t1) is elapsed after the appearance of the seed keyword 501.

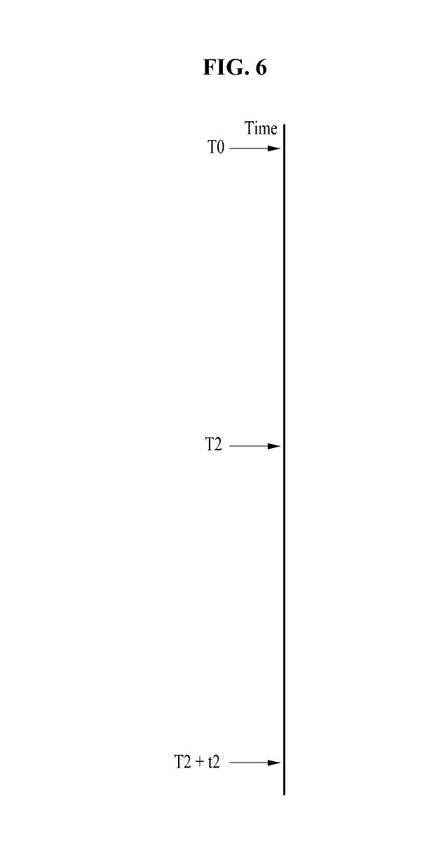

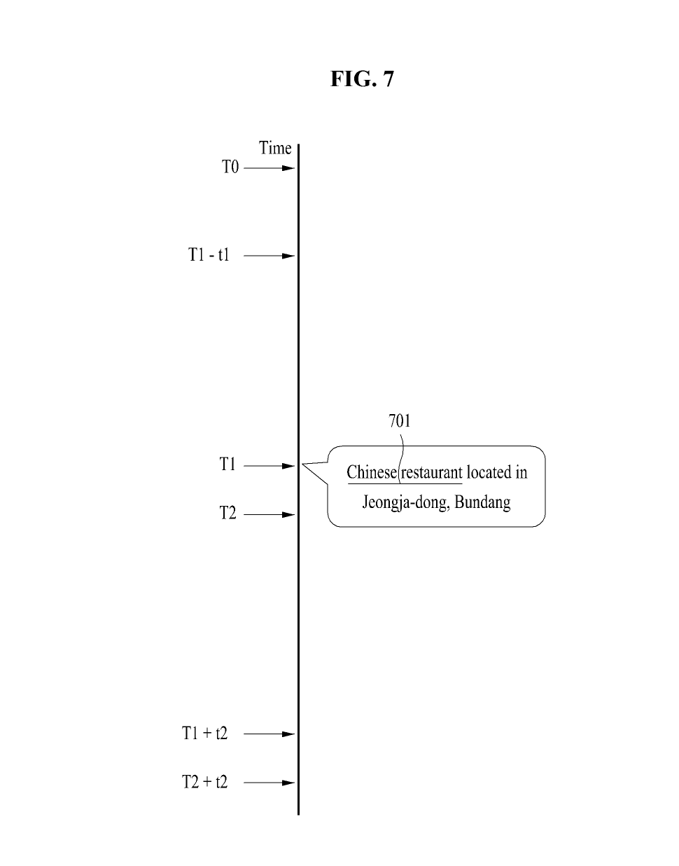

As another example, the analyzer 211 may determine a unit session based on a conversation standby time in which a mutual response is absent in the conversation session between the user and the store. Referring to FIG. 6, the analyzer 211 may separate, as a unit session, a time duration from a start point in time (T0) of a conversation to a point in time (T2+t2) of a predetermined time (t2), for example, one hour, in which no response is received after a point in time (T2) at which a last message is input.

As another example, the analyzer 211 may also determine a unit session by combining a conversation standby time and a seed keyword in a conversation session between a user and a store. Referring to FIG. 7, the analyzer 211 may separate, as the unit session, a time duration from a start point in time (T0) of a conversation in the conversation session in which a seed keyword 701 appears or a previous point in time (T1−t1) of a predetermined time (t1) before the appearance of the seed keyword 701 to a point in time (T1) at which the seed keyword 701 appeared or a point in time (T1+t2 or T2+t2) of a predetermined time (t2), for example, one hour, in which no response is received after the point in time (T1) at which the seed keyword 701 appeared or a point in time (T2) at which a last message is input.

In operation 402 of FIG. 4, the analyzer 211 calculates a store connection amount according to the conversation between the user and the store, using the unit session. For example, the analyzer 211 may calculate the store connection amount based on at least one of a conversation amount indicating the average session time, for example, a conversation duration time of the unit session and a conversation frequency indicating a number of unit sessions during a predetermined period. For example, the store connection amount may be defined by the equation: store connection amount=conversation amount (time)×conversation frequency (frequency).

Accordingly, the analyzer 211 analyzes the conversation amount and the conversation frequency between the store and the user through the messenger as ranking determining elements.

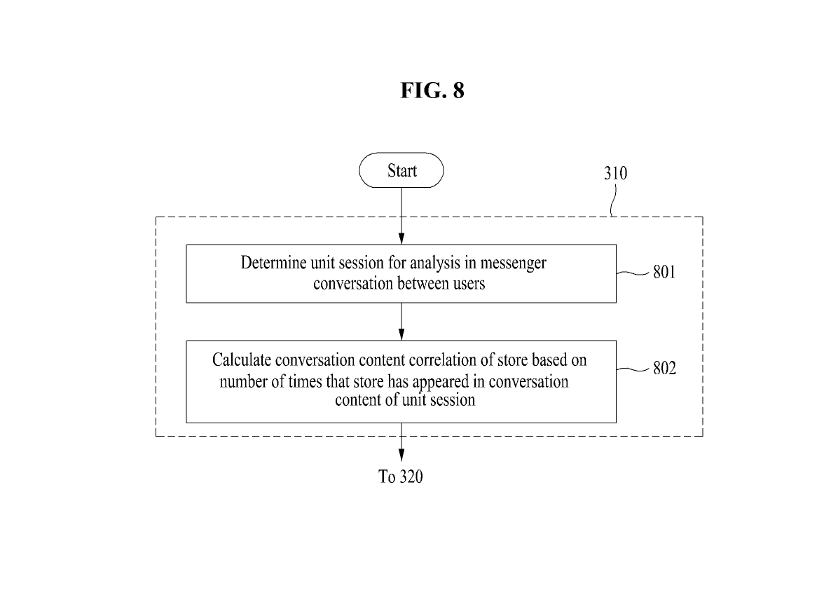

FIG. 8 is a flowchart illustrating an example of a method of analyzing a conversation content correlation according to one example embodiment. Operations 801 and 802 included in the conversation content correlation analyzing method of FIG. 8 is performed by the analyzer 211 of the search result providing system 100 described above with reference to FIGS. 2 and 3.

In operation 801, the analyzer 211 determines a unit session for analyzing a conversation content correlation between a store and conversation contents of messenger users. A method of determining the unit session is described above and thus, will be omitted here.

In operation 802, the analyzer 211 calculates the conversation content correlation of the store based on the number of times that the store has appeared in the conversation content of the unit session. That is, the analyzer 211 performs analysis on a store keyword, for example, a store name, a product name, a category name, and a site name, included in the conversation content, and analyzes the conversation content correlation of the store through combination of words used together in a single session. In this example, when keywords appear together relatively frequently in the conversation content, the similarity between the keywords may be determined to be relatively high. For example, when keywords “Chinese restaurant” and “Shang Hai Roo” appear together five times and keywords “Chinese restaurant” and “Rok'n Wok” appear together twice in a session-by-session conversation, the keyword “Shang Hai Roo” may be determined to have a relatively high correlation with the conversation content in which the keyword “Chinese restaurant” has appeared, compared to the keyword “Rok'n Wok”. Here, a reference keyword for a word combination with a store keyword such as “Chinese restaurant” may use a predefined seed keyword or may use any of keywords included in the conversation content.

An expiry time may be present for the conversation content correlation based on an issue termination. That is, a correlation between keywords may vary over time and thus, a periodical correlation analysis using a messenger conversation is required to apply the correlation between keywords varying over time.

Remaining quality factors excluding the store connection amount and the conversation content correlation may be calculated as follows.

The analyzer 211 may calculate a store response rate based on at least one of the average response time of the store with respect to a request of a messenger user and the entire response rate. Users may request the store for a specific service using the messenger, and in response thereto, the store may respond to the requested service through the messenger. For example, the store may provide a specific service, such as estimate, reservation, and advice, to messenger users using the messenger, and may respond to a user request for such functions. Accordingly, the analyzer 211 may calculate a response time in which the store responds to the user request for the specific service and a response rate of the store to the entire user requests, and may calculate a store response rate based on the calculated response time and the response rate. For example, the store response rate may be calculated by the equation: store response rate=average response time (time)×response rate (%).

Further, the analyzer 211 may calculate store accessibility from a distance between a current user location and the physical location associated with and/or referenced in the store. That is, a physical location associated with and/or referenced in the store relatively close to the current location of a messenger user may be determined to have a relatively high quality factor.

The analyzer 211 may calculate a store popularity based on at least one of the number of messenger users having set a desired (or alternatively predetermined) relationship with the store and a buzz frequency. Here, setting of the relationship may indicate all of setting actions such as registering a store to favorites on the messenger, adding the store to a friend list, and requesting following. The buzz frequency may indicate the number of documents, for example, a document posted at the store and a posted document including a store name associated with the store registered to a social network service SNS. For example, the store popularity may be defined by the expression: store popularity=number of users having set relationship×buzz frequency.

According to example embodiments of the present, it is possible to analyze a quality factor indicating the store quality on a messenger, which is a ranking standard of the store to be displayed as a search result using a feature of the messenger.

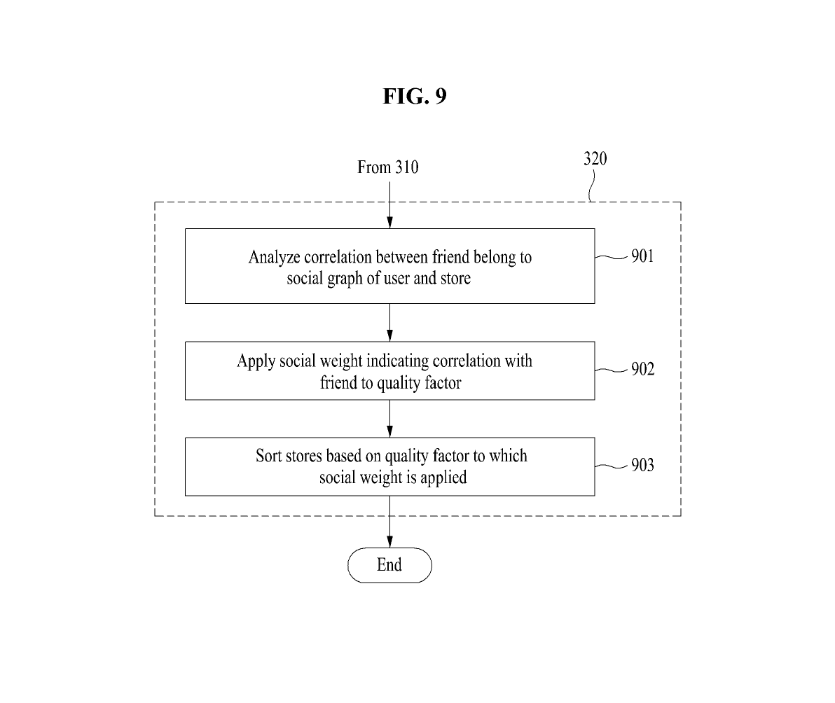

FIG. 9 is a flowchart illustrating an example of a method of determining a store ranking according to one example embodiment. Operations 901 and 902 included in the store ranking determining method of FIG. 9 is performed by the provider 212 of the search result providing system 100 described above with reference to FIGS. 2 and 3.

In operation 901, the provider 212 analyzes a correlation between a friend belonging to a social graph of a user and a store in response to a search query input by the search action of the user. That is, the provider 212 verifies a list of friends having set a relationship with the user in the social graph of a messenger, and verifies whether a friend of the user is included in a target used to analyze the quality factor of the store, whether the friend of the user has a search history for the store, whether the friend of the user has a conversation history with the store, and whether a relationship setting such as favorites, a friend add, and following, is present between the friend of the user and the store, based on log data of a messenger of the friend.

In operation 902, the provider 212 determines the ranking of the store by applying a social weight indicating a correlation with the friend of the user to the quality factor of the store. For example, when the friend of the user is included in the target used to analyze the quality factor of the store, the provider 212 may apply a weight to the quality factor of the store. As another example, the provider 212 may apply a different weight to a store having a connection history with the friend of the user, based on a connection type with the friend of the user. For example, the provider 212 may differently apply a weight, such as quality factor×1.2 when the friend of the user has a search history for the store, quality factor×2 when the friend of the user has a conversation history with the store, and quality factor×3 when the friend of the user adds the store to a friend list.

Although the social weight according to the correlation with the friend of the user is described, it is possible to apply a social weight indicating a correlation with the user. That is, the provider 212 may apply a weight to the quality factor of the store when the user is included in the target used to analyze the quality factor of the store, when the user has a search history for the store, when the user has a conversation history with the store, or when a relationship setting such as favorites, a friend add, and following, is present between the user and the store.

In operation 903, the provider 212 sorts stores based on the ranking determined in operation 902, that is, based on the quality factor to which the social weight is applied. For example, the provider 212 may provide a search result in which a store having a relatively high store quality and having a relatively high correlation with the user or the friend of the user ranks high on the messenger.

The ranking of the store may be determined by applying at least one of a time weight and an advertisement amount to the quality factor, in addition to the social weight.

The provider 212 may determine the ranking of the store by applying the time weight of the store to the quality factor based on a search point in time. In an example in which the time is divided in n time units, the provider 212 may apply (+/−)N folds of a weight to a ranking if many searches occur or do not occur in a specific time zone. For example, in the case of a store, for example, a substitute driver and a restaurant, in which search counts increase by twice or more at average in a night time zone, the provider 212 may apply a time weight corresponding to a search point in time to the quality factor of the store.

Also, the provider 212 may sort stores based on an advertisement amount and may sort the stores by applying the advertisement amount and the quality factor as store ranking standards. When a store does not have an advertisement amount, the store may be displayed as a search result using a quality factor.

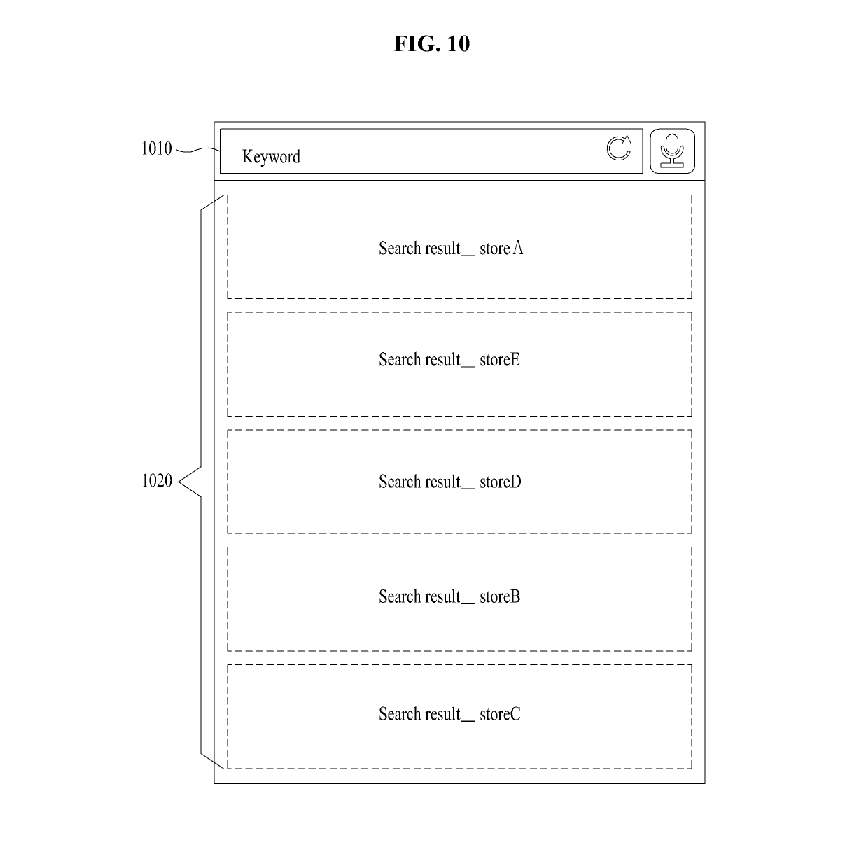

According to some example embodiments, it is possible to add a search function on a messenger and to provide a ranking in a search result for a commercial search. For example, referring to FIG. 10, when a user inputs a keyword through a search window 1010 of a messenger, a list of stores A through E may be displayed as a search result 1020 in response to the keyword. Here, in the search result 1020, the stores A through E may be displayed based on a ranking according to a store quality analyzed on the messenger.

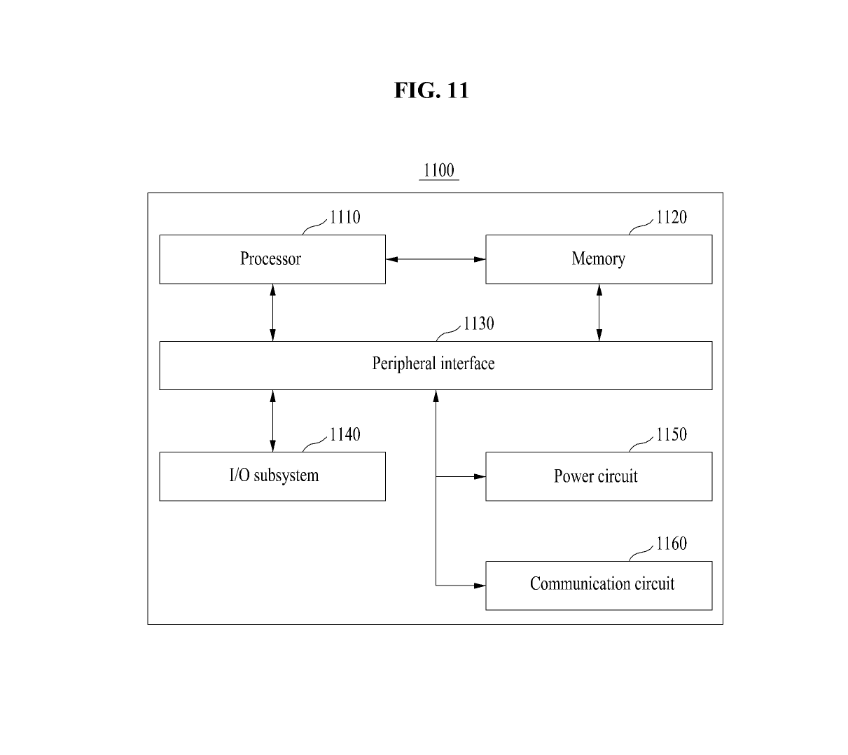

FIG. 11 is a block diagram illustrating an example of a configuration of a computer system 1100 according to an example embodiment. Referring to FIG. 11, the computer system 1100 may include at least one processor 1110, a memory 1120, a peripheral interface 1130, an input/output (I/O) subsystem 1140, a power circuit 1150, and a communication circuit 1160. Here, the computer system 1100 may correspond to the user terminal 101.

The memory 1120 may include, for example, a high-speed random access memory (HSRAM), a magnetic disk, a static random access memory (SRAM), a dynamic RAM (DRAM), read only memory (ROM), a flash memory, and a non-volatile memory. The memory 1120 may include a software module, an instruction set, or a variety of data required for an operation of the computer system 1100. Here, an access from another component such as the processor 1110 and the peripheral interface 1130 to the memory 1120 may be controlled by the processor 1110.

The peripheral interface 1130 may couple an input device and/or output device of the computer system 1100 with the processor 1110 and the memory 1120. The processor 1110 may perform a variety of functions for the computer system 1100 and process data by executing the software module or the instruction set stored in the memory 1120.

The I/O subsystem 1140 may couple various I/O peripheral devices with the peripheral interface 1130. For example, the I/O subsystem 1140 may include a controller for coupling the peripheral interface 1130 and a peripheral device such as a monitor, a keyboard, a mouse, a printer, and a touch screen or a sensor depending on a necessity. The I/O peripheral devices may be coupled with the peripheral interface 1130 without using the I/O subsystem 1140.

The power circuit 1150 may supply a power to all of or a portion of components of a terminal. For example, the power circuit 1150 may include a power management system, at least one power source such as a battery and alternating circuit (AC), a charge system, a power failure detection circuit, a power converter or inverter, a power status indicator, or other components for creating, managing and distributing power.

The communication circuit 1160 enables communication with another computer system using at least one external port. Alternatively, as described above, the communication circuit 1160 may enable communication with another computer system by including a radio frequency (RF) circuit and thereby transmitting and receiving an RF signal known as an electromagnetic signal.

The example embodiment of FIG. 11 is only an example of the computer system 1100. The computer system 1100 may have a configuration or an arrangement for omitting a portion of the components illustrated in FIG. 11, further including components not illustrated in FIG. 11, or coupling two or more components. For example, a computer system for a communication terminal of a mobile environment may further include a touch screen, a sensor, and the like, in addition to the components of FIG. 11. A circuit for radio frequency (RF) communication using a variety of communication methods, for example, wireless fidelity (Wi-Fi), 3rd generation (3G), long term evolution (LTE), Bluetooth, near field communication (NFC), and ZigBee, may be included in the communication circuit 1160. Components includable in the computer system 1100 may be configured as hardware that includes an integrated circuit specified for at least one signal processing or application, software, or a combination of hardware and software.

The methods according to the example embodiments may be configured in a program instruction form executable through various computer systems and thereby recorded in non-transitory computer-readable media.

A program according to the example embodiments may be configured as a PC-based program or an application exclusive for a mobile terminal. A search result providing App according to the example embodiments may be configured in an in-app form of a specific application, for example, a messenger program, and may be operable on the specific application.

Further, the methods according to the example embodiments may be performed in such a manner that the search result providing App controls the user terminal. The application according to the example embodiments may be installed in the user terminal through a file provided from a file distribution system. As an example, the file distribution system may include a file transmitter (not shown) to transmit the file in response to a request from the user terminal.

As described above, according to some example embodiments, it is possible to induce traffic of a new model and to improve the usability and availability of a mobile messenger by providing a search function to the mobile messenger. Also, according to some example embodiments, it is possible to provide a search result optimized for a mobile messenger by providing a commercial search result based on a ranking determining element in which features of the mobile messenger are applied.

The units and/or modules described herein may be implemented using hardware components, software components, or a combination thereof. For example, the hardware components may include microcontrollers, memory modules, sensors, amplifiers, band-pass filters, analog to digital converters, and processing devices, or the like. A processing device may be implemented using one or more hardware device(s) configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device(s) may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors, multi-core processors, distributed processing, or the like.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, and/or computer storage medium or device. The software also may be distributed over network coupled computer systems so that the software is stored and executed in a distributed fashion. The software and data may be stored by one or more computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of some example embodiments, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described embodiments, or vice versa.

It should be understood that example embodiments described herein should be considered in a descriptive sense only and not for purposes of limitation. Descriptions of features or aspects within each device or method according to example embodiments should typically be considered as available for other similar features or aspects in other devices or methods according to example embodiments. While some example embodiments have been particularly shown and described, it will be understood by one of ordinary skill in the art that variations in form and detail may be made therein without departing from the spirit and scope of the claims.

What is claimed is:

1. A search result providing method implemented in a computer having a processor, wherein the method provides a search function on a messenger and provides information associated with stores as a search result by the search function, and comprises:
analyzing, by the processor, a quality factor indicating a store quality associated with the messenger with respect to each store; and
sorting, by the processor, the search result by determining a ranking of a store based on the quality factor.

2. The method of claim 1, wherein the analyzing comprises analyzing the quality factor based on at least one of a store connection amount indicating a conversation connection level between users and the store through the messenger and a conversation content correlation indicating a correlation between conversation contents of the users through the messenger and the store.

3. The method of claim 1, wherein the analyzing comprises:
analyzing a store connection amount indicating a conversation connection level between users and the store through the messenger; and
calculating the store connection amount based on at least one of a conversation duration time and a conversation frequency between a user and the store.

4. The method of claim 1, wherein the analyzing comprises:
analyzing a conversation content correlation indicating a correlation between conversation contents of the users through the messenger and the store; and
calculating the conversation content correlation based on the number of times that a keyword associated with the store has appeared in the conversation contents.

5. The method of claim 1, wherein the analyzing comprises:
analyzing a store connection amount indicating a conversation connection level between users and the store through the messenger;
determining a unit session for analyzing the store connection amount in a conversation session in which a user and the store are connected; and
calculating the store connection amount based on at least one of the number of unit sessions and a session duration time.

6. The method of claim 1, wherein the analyzing comprises:
analyzing a conversation content correlation indicating a correlation between conversation contents of the users through the messenger and the store;
determining a unit session for analyzing the conversion content correlation in a conversation session in which the users are connected; and
calculating the conversation content correlation based on the number of times that a keyword associated with the store has appeared in the conversation contents.

7. The method of claim 5, wherein the analyzing comprises determining, as the unit session, a session from an appearance point in time of a predefined seed keyword in the conversation session to a point in time at which a desired period of time is elapsed after the appearance point in time of the seed keyword, using the seed keyword.

8. The method of claim 5, wherein the analyzing comprises determining, as the unit session, a session from a start point in time of a conversation to a point in time of a predetermined time in which no reply is received after an input of a last message in the conversation.

9. The method of claim 2, wherein the analyzing comprises analyzing the quality factor based on at least one of a store response rate indicating a rate at which the store has responded to a request of a user for a specific service of the store using the messenger, a store accessibility indicating a distance between a location of the user using the messenger and a physical location associated with the store, and a popularity of the store among users using the store.

10. The method of claim 1, wherein the sorting comprises determining the ranking of the store by applying a weight to the quality factor based on at least one of a correlation between a user and the store and a correlation between a friend having set a relationship with the user and the store.

11. The method of claim 10, wherein the weight is determined based on at least one of whether a messenger conversion of the user or the friend is used to analyze the quality factor, whether a search history by the user or the friend is present, whether a conversation history with the user or the friend is present in the messenger, and whether a favorites or friend registration history by the user or the friend is present in the messenger.

12. The method of claim 1, wherein the sorting comprises determining the ranking of the store by applying a weight to the quality factor based on a search frequency for each time zone of the store through the search function.

13. A search result providing system comprising:
a processor; and
a memory,
wherein the processor is configured to provide a search function on a messenger and to provide information associated with stores as a search result of the search function, and comprises:
an analyzer configured to analyze a quality factor indicating a store quality associated with the messenger with respect to each store; and
a provider configured to sort the search result by determining a ranking of a store based on the quality factor.

14. The search result providing system of claim 13, wherein the analyzer is further configured to analyze the quality factor based on at least one of a store connection amount indicating a conversation connection level between users and a store through the messenger and a conversation content correlation indicating a correlation between conversation contents of the users through the messenger and the store.

15. The search result providing system of claim 13, wherein the analyzer is further configured to analyze a store connection amount indicating a conversation connection level between users and the store through the messenger, to determine a unit session for analyzing the store connection amount in a conversation session in which a user and the store are connected, and to calculate the store connection amount based on at least one of the number of unit sessions and a session duration time.

16. The search result providing system of claim 13, wherein the analyzer is further configured to analyze a conversation content correlation indicating a correlation between conversation contents of the users through the messenger and the store, to determine a unit session for analyzing the conversion content correlation in a conversation session in which the users are connected, and to calculate the conversation content correlation based on the number of times that a keyword associated with the store has appeared in the conversation contents.

17. The search result providing system of claim 14, wherein the analyzer is further configured to analyze the quality factor based on at least one of a store response rate indicating a rate at which the store has responded to a request of a user for a specific service of the store using the messenger, a store accessibility indicating a distance between a location of the user using the messenger and a physical location associated with the store, and a popularity of the store among users using the store.

18. The search result providing system of claim 13, wherein the provider is further configured to determine the ranking of the store by applying a weight to the quality factor based on at least one of a correlation between a user and the store and a correlation between a friend having set a relationship with the user and the store.

19. The search result providing system of claim 13, wherein the provider is further configured to determine the ranking of the store by applying a weight to the quality factor based on a search frequency for each time zone of the store through the search function.

20. A non-transitory computer-readable medium including computer-readable instructions, wherein when executed by a processor, the computer-readable instructions are configured to control a computer system to provide a search function on a messenger and provide information associated with stores as a search result by the search function, and comprising:
analyzing a quality factor indicating a store quality associated with the messenger with respect to each store; and
sorting the search result by determining a ranking of a store based on the quality factor.
